(19) United States
(12) Patent Application Publication
(10) Pub. No.: US 2017/0294136 A1
(43) Pub. Date: Oct. 12, 2017

(54) GRAPHICAL USER INTERFACE FOR INTERACTIVE COGNITIVE RECOGNITION SPORTS TRAINING SYSTEM

(71) Applicant: Axon Sports, LLC, Wausau, WI (US)

(72) Inventor: Jason Sada, Scottsdale, AZ (US)

(21) Appl. No.: 15/436,884

(22) Filed: Feb. 20, 2017

Related U.S. Application Data
(63) Continuation-in-part of application No. 15/147,893, filed on May 5, 2016.
Application No. 15/147,893 is a continuation of application No. 13/985,868, filed on Aug. 15, 2013, now abandoned.
(60) Provisional application No. 61/443,201, filed on Feb. 15, 2011.

(51) Int. Cl. G09B 19/00; G09B 7/06; G09B 7/08; G09B 5/06

(52) U.S. Cl. CPC G09B 19/00; G09B 5/06; G09B 7/06; G09B 19/0038; G09B 7/08; G06F 3/04842

(57) ABSTRACT

According to methods for teaching high performance cognitive skills, a simulated sports action scenario is displayed on a screen to a user, and the user is queried to respond to the scenario. The user's response to the scenario is received. The user's response to the scenario is evaluated according to predetermine high performance cognitive skills criteria to determine a sports relevant score. The determined sports relevant score is then displayed to the user and a database is updated. A graphical user interface is provided to enable the foregoing.

### CROSS REFERENCE TO RELATED APPLICATIONS

This application is a continuation-in-part of U.S. patent application Ser. No. 15/147,893, filed May 5, 2016, which is a continuation of U.S. patent application Ser. No. 13/985,868, filed Aug. 15, 2013 which is the U.S. National Stage of PCT/US2012/025320, filed Feb. 15, 2012, which claims the benefit of U.S. Provisional Patent Application No. 61/443,201, filed Feb. 15, 2011, the disclosures of each of which are hereby incorporated by reference in their entireties.

### FIELD OF THE INVENTION

The invention relates generally to a graphical user interface which enables interaction with and use of software approaches to assessing and training high-performance cognitive skills.

### BACKGROUND

Providing training to help others acquire, measure and improve high-performance cognitive skills has many benefits. Such skills, which include high speed decision making, pattern recognition, spatial reasoning, visualization, imagination, focus, concentration, emotional regulation, relaxation, reaction and anticipation, among others, play crucial roles in many activities. Research shows that cognitive skills can be trained and improved through deliberate practice.

High-speed decision making is important in activities such as operating vehicles, deciding to use deadly force, air traffic control and sports, to name a few. Past efforts to train high-speed decision making have included training batters in pitch recognition by displaying video of a pitch being delivered, stopping the action in time, i.e., occluding the scene, and then prompting the user to recognize the pitch correctly. Pitch recognition can include recognizing the type of pitch being thrown (e.g., fastball, curve ball, slider, changeup, etc.), whether the pitch will pass through the strike zone and/or the location of the pitch when it crosses home plate. U.S. Patent Application Publication 2207/0005540 A1, which is incorporated herein by reference, discloses aspects of pitch recognition training.

Training of high-performance cognitive skills such as high-speed decision making could still be improved, however, such as by enhancing the feedback provided to users, developing metrics to characterize results and improving simulation of the real-world experience.

### SUMMARY

Described herein are improved approaches to assessing and training high-performance cognitive skills, both in the sports domain as well as in other domains. According to a first approach, there is a computer-readable storage medium storing computer-executable instructions for causing a computer to perform a method for teaching high performance cognitive skills that includes displaying to a user a simulated sports action scenario, querying the user to respond to the sports action scenario and receiving the user's response to the sports action scenario. The user's response is evaluated according to predetermined high performance cognitive skills criteria to determine a sports specific rating. The determined sports specific rating is displayed to the user, and a database is updated.

The teaching of high performance cognitive skills can include teaching of high speed decision making. Evaluating the user's response can comprise considering at least whether the user's response is correct and a response time for the user to complete the user's response.

The teaching of high performance cognitive skills can include teaching of pattern recognition. Pattern recognition is the skill that allows one to identify and respond appropriately to complex patterns, which may be comprised of faces, objects, words, melodies, chessboards, sports scenarios and the like. Pattern recognition is used to describe the process of recognizing a set of stimuli arranged in a meaningful pattern that is characteristic of that set of stimuli, associating that pattern with a similar pattern stored in long term memory and responding with a response which the brain recognizes as appropriate for that stored pattern. Pattern recognition does not occur instantly, but rather is a skill that develops through deliberate practice in a specific domain. Pattern recognition is understood to happen automatically and spontaneously in expert performers. According to one theory, pattern recognition is said to involve detection, pattern dissection, feature comparison in memory and recognition. The ability to practice these skills with many high speed repetitions has been demonstrated to improve an individual's skill when it comes to domain-specific pattern recognition.

Evaluating the user's response can comprise considering at least whether the user's response is correct.

The acts of querying the user and receiving the user's response can be configured to require the user to complete at least one part task related to an overall whole task.

The acts of displaying, querying, receiving, evaluating and displaying can be performed repeatedly as desired by the user to allow the user to develop the high performance cognitive skills.

Receiving the user's response can comprise receiving the user's decision within a predetermined domain selected for training the user in a specific skill.

The act of displaying can comprise occluding a scene to target development of the user's high speed decision making and/or pattern recognition skills. Occluding a scene can comprise stopping the video after only a portion of the action has been displayed. Forcing the user to repeatedly respond to the video or other stimulation after occlusion requires the user to automatize pattern recognition, thus sharpening the user's skills in a way that would otherwise require many on-field hours of play in a far less focused setting. Indeed, some skills such as having batters face a major league caliber pitcher are not currently practiced except in actual game situations.

The teaching of high-performance cognitive skills can include loading the action sports scenario, i.e., increasing the cognitive load on the user, to increase the user's difficulty in responding correctly. Loading can comprise playing a predetermined audio selection concurrent with displaying the simulated sports action scenario. The audio selection can comprise at least one of crowd noise, white noise and distracting sounds. Responding to the sports action scenario can be a first task, and the loading can comprise querying the user to complete a second task concurrent with the first task. The second task can be querying the user to recite a passage. The loading can relate to a game breaking situation that magnifies the emotional demands on the user, thus leading to improved skills in emotional regulation and focus.

Displaying the determined sports specific rating to the user can comprise displaying feedback to the user. The feedback can comprise coaching of techniques to improve the user's sports specific rating. The feedback can comprise simultaneously showing an incorrect user-selectable response in a first visual format and showing a correct user-selectable response in a second visual format distinct from the first visual format. Displaying a sports specific rating can comprise displaying a graphic representing current progress toward a goal, a comparison to previous efforts, a comparison to others generally or within a subset (e.g., other athletes, others in the same age group, others of the same level of experience, etc.)

Evaluating the user's response can comprise assigning a deduction to the sports specific rating for an incorrect user response. The deduction can be based on the user's position in the action sports scenario or the timing of the user's response. Evaluating the user's response can also comprise weighing relevant scores for other users. Evaluating the user's response can include evaluating the user's ability in pattern recognition or the user's ability to rapidly anticipate or respond to a domain-specific cognitive demand.

Displaying to a user a simulated sports scenario and displaying the determined sports specific rating to the user can comprise displaying at least one of video, still images and 3D-simulations.

The act of querying the user to respond to the sports action scenario comprises displaying at least two touch-selectable objects on a touch-sensitive screen. The act of receiving the user's response to the sports action scenario can comprise determining a contact with a touch-sensitive screen.

The act of receiving the user's response can comprise receiving a physical input from the user that includes a decisive motion. The act of receiving the user's response can comprise receiving a physical input from the user that includes a decisive motion mimicking a portion of a sports relevant action.

The method for teaching high performance cognitive skills can be carried out according to at least one of a first mode configured to train a user for speed and a second mode configured to train a user for accuracy. According to one approach, assessment of a user's skills combines both speed and accuracy to arrive at an index or score that reflects that athlete's relative performance to a domain-relevant cognitive skill.

The simulated sports action scenario can be an initial test scenario to familiarize the user. Any response by the user to the initial test scenario can be configured not to count toward a final sports specific rating.

According to another approach, there is a computer-readable storage medium storing computer-executable instructions for causing a computer to perform a method for reducing a time required to teach high performance cognitive skills to a user, and the method comprises, in response to a displayed simulated action scenario, evaluating a user's response, determining a subsequent simulated action scenario for display to the user, and repeating the method until a predetermined length of time elapses, a predetermined number of situations are presented or a predetermined improvement in the user's time occurs.

The user can be required to repeat a predetermined part task many times. Displaying the subsequent simulated action scenario can include providing feedback to the user targeted to improve the user's acquisition of high performance cognitive skills.

According to another approach, there is a computer-readable storage medium storing computer-executable instructions for causing a computer to perform a method for assessing sports specific cognitive skills that includes displaying to a user a simulated sports action scenario and querying the user to respond, receiving the user's response to the sports action scenario and evaluating the user's response according to a cognitive skills assessment index. The user's response is assigned a rating based on the cognitive skills assessment index, and the rating is displayed to the user.

According to another approach, there is a computer-readable storage medium storing computer-executable instructions for causing a computer to perform a method, and the method comprises displaying to a user a video of an action scenario and at least two possible responses to the action scenario, displaying at least two user-selectable responses to the user, measuring an elapsed time between display of the action scenario and the user's selection of a user-selectable response, generating an action scenario score based on at least one of the subject's selection and the elapsed time between the action scenario and the selection.

The method can comprise setting a user selection time window. The method can comprise displaying a graphic corresponding to time remaining in the user selection time window, displaying a current action scenario score, displaying a cumulative action scenario score, and/or displaying a graphic representing current progress toward a goal. The method can comprise displaying a cumulative action scenario score relative to a goal score, displaying a graphic showing how many situations have been completed relative to a total number of situations and/or displaying action scenarios answered correctly in a distinct manner from action scenarios answered incorrectly.

The method can comprise displaying feedback to the user by showing an incorrect user-selectable response in a first visual format and showing a correct user-selectable response in a second visual format distinct from the first visual format. The first visual format can be a first color, and wherein the second visual format can be a second color distinct from the first color.

Generating an action scenario score can include applying a position factor according to the user's position within the action scenario.

Displaying to a user a video of an action scenario can comprise displaying the action scenario to at least a first user and a second user simultaneously, and scaling the respective action scenario score for the first user and the second user based on the respective elapsed times.

The method can comprise displaying instructions to the user to complete a secondary task simultaneously with display of the action scenario, and wherein generating an action scenario score can comprise assessing the user's performance in completing the secondary task. Assessing the user's performance can comprise soliciting a response from the user to at least one question testing the user's short term recall for visual information and/or audio information.

Generating an action scenario score can comprise assigning a deduction for an incorrect user-selectable response, and wherein the deduction is based on the user's position in the action scenario. The deduction can be based on the timing of the incorrect user-selectable response in the action scenario.

Further described herein the improved approaches to assessing and training high-performance cognitive skills comprise a graphic user interface configured to be displayed on an electronic display.

In an embodiment, sports-related icons and color schemes, which may correspond to teams, are provided from a server and used as the background or theme of a user interface during a user's experience with the graphical user interface. Preferably, the sports-related icons and color schemes are selected based on a user's account information which specifies the user's team affiliation(s) or preferences. In a further embodiment, photographs, leaderboards, and featured athletes may appear within the background or theme. Said background or theme increases user usage, activity, engagement, retention and affiliation with the system.

In another embodiment, the graphical user interface has a three section display, arranged top to bottom having key user engagement elements in the top section including a dashboard element having one or more of training goal repetitions count, performance percentile, leaderboard, training tier and achievements.

In yet another embodiment, the graphical user interface has a drill interface divided into a top and bottom section. The top section shows type of drill and user progress. The bottom section shows details of a selected drill.

In another embodiment, the graphical user interface has a training and instruction interface which provides drill parameters, required accomplishments and differentiates information presented by category.

In an embodiment, the training interface is entered via a countdown screen that allows a user to enter a training mindset prior the training program starting. The training interface has optimized placement of buttons based on the real world positioning of a corresponding athlete and by response category. The training interface also includes scoring and user pressure features. The training interface preferably occludes images when answers are displayed so that the user receives substantially no more information beyond the answer. The training interface preferably includes scoring and presentation of correct answers when the user receives an incorrect answer.

In a further embodiment a results screen (also called a training summary) presents the results of a training session to the user and enables a quick restart so that users can quickly start an additional session.

### BRIEF DESCRIPTION OF THE DRAWINGS

FIG. 1 is a drawing showing an initial screen of the sports training system in operation on a computer.

FIG. 2 is a drawing showing a sign-in and registration screen.

FIG. 3 is a drawing showing a sports selection screen from which a user selects one sport or activity in which to receive training.

FIG. 4A is a drawing showing a baseball activity screen presenting a user with a choice between facing a left-handed pitcher and a right-handed pitcher.

FIG. 4B is a drawing showing a screen presenting the user with a choice between two different left-handed pitchers.

FIGS. 5A and 5B are drawings showing options for different left-handed pitcher modules.

FIG. 6 is a drawing showing the screen for a ball-strike identification activity.

FIG. 7 is a drawing showing an initial screen for the ball-strike identification video before the activity has commenced and showing the pitcher at rest.

FIG. 8 is a drawing showing a frame of the ball-strike identification video after the pitcher has begun his wind-up.

FIG. 9 is a drawing showing a frame of the ball-strike identification video after it has been occluded and the user has correctly responded that the pitcher's first pitch was a strike.

FIG. 10A is a drawing showing another frame of the ball-strike identification video after it has been occluded and the user has incorrectly responded that the pitcher's second pitch was a strike.

FIG. 10B is a drawing showing another frame of the ball-strike identification video after it has been occluded and the user has incorrectly responded that the pitcher's third pitch was a strike.

FIG. 11 is a drawing showing another frame of the ball-strike identification video after it has been occluded and the user has correctly responded that the pitcher's fourth pitch was a strike.

FIG. 12A is a drawing showing a frame of a second round of the ball-strike identification video after the user has responded incorrectly to a first pitch but before the second pitch has been thrown.

FIG. 12B is a drawing showing the second round of the ball-strike identification video after the user has responded correctly to a second pitch but before the third pitch has been thrown.

FIG. 13 is a drawing showing the second round of the ball-strike identification video after the user has responded incorrectly to a third pitch but before the fourth pitch has been thrown.

FIG. 14A is a drawing showing the second round of the ball-strike identification video after the user has responded incorrectly to a fifth pitch but before the sixth pitch has been thrown.

FIG. 14B is a drawing showing a pitch recognition scenario.

FIG. 14C is a drawing showing a scenario allowing for batting practice.

FIG. 15 is a drawing showing the football positions screen after the user has selected football from the sports selection screen.

FIG. 16A is a drawing showing the strength recognition drills being selected for the left linebacker position.

FIG. 16B is a drawing showing the left linebacker drills options of train for accuracy or train for speed.

FIG. 17 is a drawing showing a frame of a blitz recognition video before the first play has concluded.

FIG. 18 is a drawing showing a frame of a blitz recognition video after it has been occluded and the user has responded correctly that the defense was blitzing in the middle in the first play.

FIG. 19 is a drawing showing a frame of the blitz recognition video after it has been occluded and the user has responded incorrectly that the defense was blitzing to the left in the second play.

FIG. 20 is a drawing showing a frame of the blitz recognition video after it has been occluded and the user has responded correctly that the defense was blitzing to the right in the third play.

FIG. 21 is a drawing showing a frame of the blitz recognition video after the user has responded incorrectly that the defense was blitzing in the middle in the fourth play.

FIG. 22 is a drawing showing a frame of the blitz recognition video after the user has responded incorrectly that the defense was blitzing both ways in the fifth play.

FIG. 23 is a drawing showing a frame of the blitz recognition video after the user has responded incorrectly that the defense was blitzing to the left in the sixth play.

FIG. 24 is a drawing showing a frame of an offensive formation recognition video before the first play.

FIG. 25 is a drawing showing a frame of the offensive formation recognition video after the first play.

FIG. 26A is a drawing showing a frame of a defensive coverage recognition video after three plays where the user must recognize whether the defense is in a cover two man formation, or has 0, 1, 2, 3 or 4 down linemen, or is in a quarter or half-dollar formation.

FIG. 26B is a drawing showing a frame of the defensive coverage recognition video after four plays where the user has answered incorrectly for the fourth play.

FIG. 27 is a drawing showing the soccer positions screen after the user has selected soccer from the sports selection screen.

FIG. 28 is a drawing showing the basketball positions screen after the user has selected basketball from the sports selection screen.

FIG. 29 is a drawing showing a generalized example of a suitable computing environment in which embodiments of systems and methods of aggregating media content can be implemented.

FIG. 30 is a drawing showing a server computer, network, and client devices.

FIG. 31 is a drawing showing a network which can send and receive information and media content to computing devices.

FIG. 32 is a drawing showing the manner in which computer-executable instructions for performing embodiments of the present invention can be transmitted, accessed, or received using a remote server computer.

FIGS. 33-49 depict graphical user interface screens of an embodiment of the present invention.

### DETAILED DESCRIPTION

Described below are implementations of a training system for teaching and assessing a user's high performance cognitive skills. Cognitive skills are those that allow us to think, remember and learn. Cognitive skills are necessary for analyzing sounds and images, recalling information, making associations and maintaining focus. A non-exhaustive list of cognitive skills includes processing speed, auditory processing, visual processing, long-term memory, short-term memory, logic and reasoning, and attention skills. The selected cognitive skill(s) that is the subject of a particular training segment may be geared for a specific cognitive task linked to a sport or activity involving high-performance cognitive skills (including, as just a few examples, driving, air traffic control, decisions to use deadly force, etc.).

In some implementations, the training system is embodied as a computerized system in which the content is presented to the user via a display, such as a conventional display for a desktop, laptop or tablet computer, smart phone, television or other suitable display.

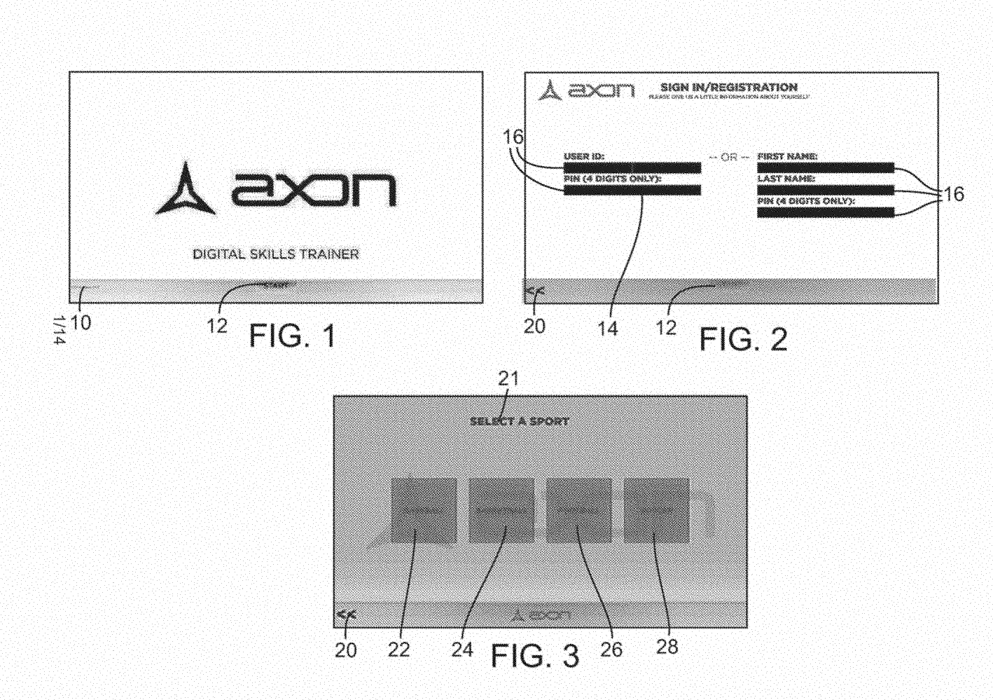

FIG. 1 is a screen shot of such a display showing the training system start screen 10 configured for sports specific training. To initiate use of the system, the user selects the Start button 12. FIG. 2 is a screen shot showing the training system's registration and log in screen 14. The user enters her credentials in the fields 16 and presses the Start button 12 to advance.

FIG. 3 is a screen shot showing an activity selection screen 20. In the illustrated implementation, the activity selection screen has a Baseball button 22, a Basketball button 24, a Football button 26 and a Soccer button 28. As discussed elsewhere, the training system can be used to teach high performance cognitive skills in many areas outside of sports, such as driving a vehicle, handling a firearm, air traffic control, etc.

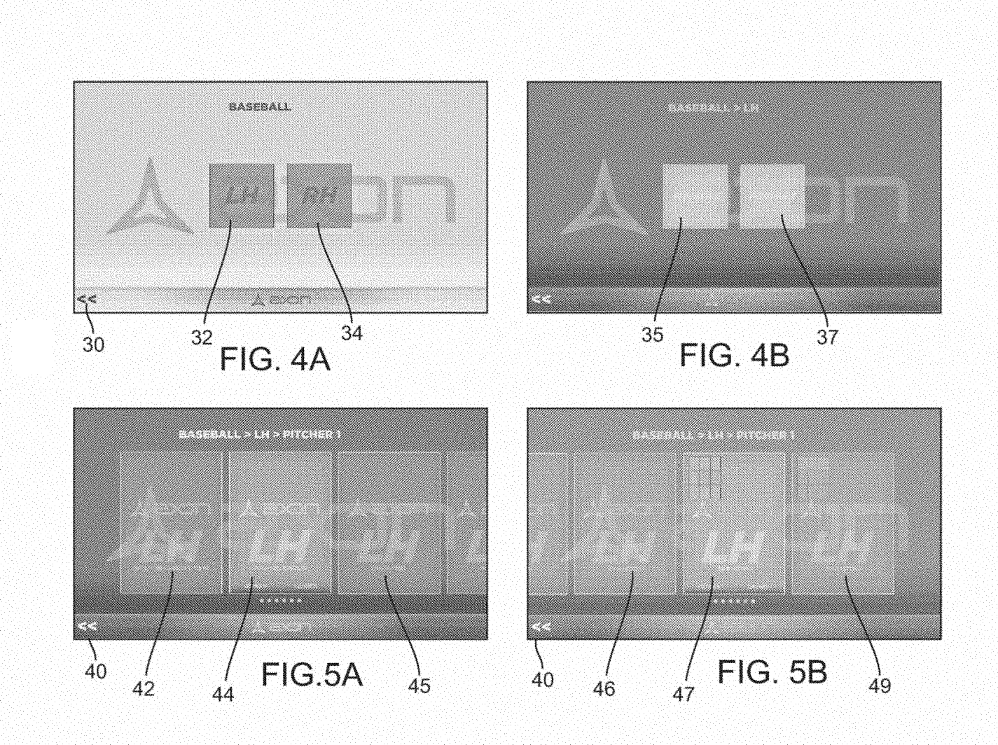

FIG. 4A is a screen shot showing a Baseball menu options screen 30 displayed after the user has selected the Baseball button 22. The user can choose to face a left-handed pitcher by selecting a LH button 32 or a right-handed pitcher by selecting a RH button 34. In FIG. 4B, the user selects between two different left-handed pitchers by selecting a Pitcher 1 button 35 or a Pitcher 2 button 37. Once a left-handed pitcher has been selected, various training modules involving a left-handed pitcher are displayed for selection to the user in a training modules screen 40 as shown in FIGS. 5A and 5B. The user can scroll left and right to choose her desired module. In the illustrated implementation, these modules include Ball/Strike Identification 42, Pitch Recognition 44, Quads Drill 45, and three different versions of zone hitting, including Zone Hitting 46, Zone Hitting 47 and Zone Hitting 49. As can be seen in FIG. 5B and the strike zone graphics, the Zone Hitting 47 and Zone Hitting 49 modules are each designed to train the user at hitting pitches in a different area of the strike zone.

### Baseball Scenarios

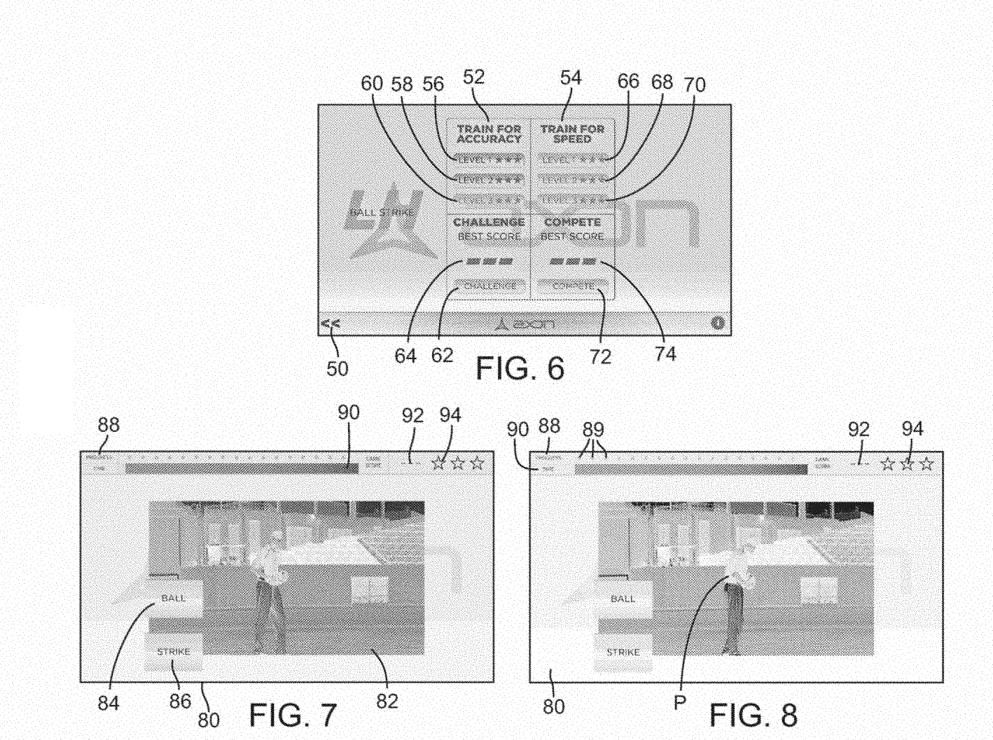

In the example of FIG. 6, the user has selected the Ball/Strike Identification 42 module, and in the Ball/Strike Identification screen 50, the user is given the option to select a Train for Accuracy 52 module or a Train for Speed 54 module. Within the Train for Accuracy 52 module shown on the left, a Level 1 indicator 56, a Level 2 indicator 58 and a Level 3 indicator 60 are displayed. Similarly, within the Train for Speed 54 module, a Level 1 indicator 66, a Level 2 indicator 68 and a Level 3 indicator 70 are displayed. The user can choose any level that is not “greyed out.” Thus, the user can choose from the Level 1 indicator 56 and the Level 2 indicator 58. The Best Score fields 64, 74 would display the best scores previously achieved in each of the modules, but in the illustrated implementation are blank because the system was previously reset. The user selects the Challenge button 62 to proceed with the Train for Accuracy module against a left-handed pitcher in Ball/Strike Identification.

In general, all levels can be active at the time the scenario is initiated, or only a selected one or more levels can be enabled, e.g., based on a user's performance. In a Train for Accuracy module, scoring is weighted more heavily on the accuracy of the response than on the speed of the response. For some situations, the system is configured to give the speed of response zero weight, which means that the accuracy of the response is given full weight.

Conversely, in a Train for Speed module, the speed of the response is weighted more heavily than the accuracy of the response. In most cases, points will be awarded only for accurate responses, but achieving all possible points will require a very fast response. Thus, it is possible that a correct response made too slowly will not earn any points.

The Challenge mode is time-based and challenges the user to respond to as many situations as she can in an allotted amount of time. Feedback is typically turned on during use of the Challenge mode so the user can receive this benefit during the training. At the end of the allotted time, the user is given a score and an optional star value. The best score for a similar Challenge mode (or scrimmage) is shown in the Challenge Best Score field 64.

The Compete mode is time-based. A user attempts to respond to as many situations as she can in an allotted time. Feedback is typically turned off during the Compete mode, so the user is not apprised of her progress until the training session is completed. At the end of the allotted time, the user is given a score and an optional star value. The Compete mode can be selectively disabled to reinforce other types of training and preserve its use for particular purposes. For example, the Compete mode can be limited to one use per day for a selected athlete or class of athletes to urge them to train in and learn from other modes (and the feedback provided) before simply repeating the Compete mode in an effort to earn a higher score. These examples are illustrative only, and thus it is possible to configure access to the various modes in many different ways.

In FIG. 7, a Ball/Strike scenario screen 80 is shown with a video 82 of a left-handed pitcher P preparing to throw a first pitch. A Ball button 84 and a Strike button 86 are superimposed on the screen and in this example, at least partially over the video 82. The buttons 84 and 84 are preferably touch-sensitive. In this example, the user is playing a left-handed batter, so the buttons are placed on the left side of the video, which is the most intuitive position considering a left-handed batter's stance and swinging action.

A progress bar 88 shows how many segments have been completed (in this example, no segments have been completed), as well as the total number of segments for the scenario (there are 15 total segments). A time bar 90 provides a visual indication of how much time is left in the scenario. A game score field 92 indicates the current score (the “---” indicates that no segments have been completed). The star ratings 94, which are currently unfilled, indicate the user's performance relative to one or more ratings or rankings.

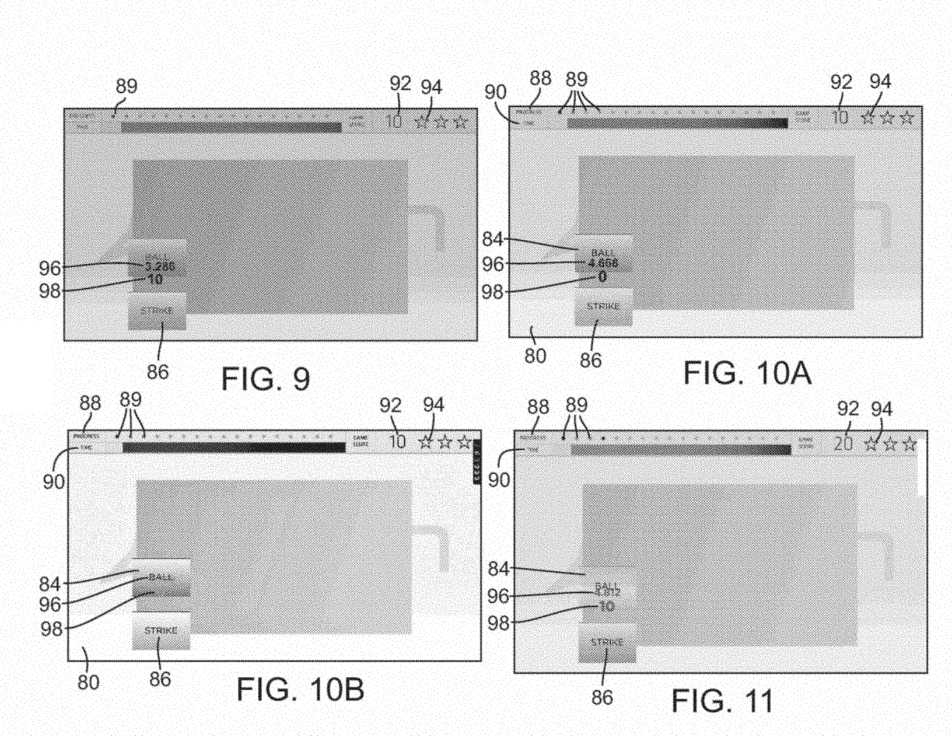

The Ball/Strike scenario trains the user to discern between pitches that would be within the strike zone (strikes) and pitches that would be outside of the strike zone (balls). The user needs to indicate her choice by selecting the Ball button 84 or the Strike button 86 as soon as possible after the pitcher begins his delivery of a pitch. Points are awarded for answering correctly and answering within a predetermined amount of time. FIG. 8 is another view of the Ball/Strike scenario similar to FIG. 7, except it can be seen that the pitcher P has begun moving to deliver a first pitch.

FIG. 9 is another view of the Ball/Strike scenario after the first pitch has been released, and the user has responded that the first pitch was a strike by selecting the strike button 86. Also, FIG. 9 shows that the video is blank or black, i.e., that the scene has been optionally occluded.

Following the user's response, feedback is provided. According to a first form of feedback, the user's response is color coded. In this case, the Strike button 86 is shaded (e.g., green) to indicate that the user's response was correct. According to a second form of feedback, the user's response time 96 is shown, i.e., the user can immediately see that she responded in 3.286 seconds. According to a third form of feedback, the user's score 98 for the current pitch is shown, in this case near the response time 96, i.e., the user can instantly appreciate that she earned 10 points for her correct response. In the progress bar 88, the first indicator 89 is filled, thus indicating that one pitch, repetition, situation or segment of the scenario is concluded. The fifteen unfilled indicators indicate that there are fifteen situations (also referred to as “questions” or “repetitions”) yet to be responded to in the scenario. Moreover, the indicator can be shaded (e.g., green) to indicate that the user's response to the first pitch was correct. The game score field 92 has been updated to indicate that the user has a total score of 10 points thus far into the scenario.

FIG. 10A shows another view of the Ball/Strike scenario after the user has responded to the second pitch. As in the case of FIG. 9, FIG. 10A shows the screen while the video is occluded. The user has responded incorrectly that the pitch was a strike, so the Ball button 84 and the Strike button 86 are shaded accordingly. Also, the user's response time 96 of 4.668 seconds and score 98 of 0 points are displayed near the buttons 84, 86. The second indicator 89 is filled in, and can be shaded to show that the response was incorrect. The time bar indicates that some time has elapsed. The user's total score 92 remains 20 points.

FIG. 10B shows another view of the Ball/Strike scenario after the user has responded to the third pitch. As in the case of FIG. 9, FIG. 10A shows the screen while the video is occluded. Once again, the user has responded incorrectly that the pitch was a strike, so the Ball button 84 and the Strike button 86 are shaded accordingly. Also, the user's response time 96 of 4.759 seconds and score 98 of 0 points are displayed near the buttons 84, 86. The third indicator 89 is filled in, and can be shaded to show that the response was incorrect. The time bar indicates that additional time has elapsed. The user's total score 92 remains 20 points.

FIG. 11 shows another view of the Ball/Strike scenario after the user has responded to the fourth pitch. As in the case of FIGS. 9, 10A and 10B, FIG. 11 shows the screen while the video is occluded. The user has responded correctly that the pitch was a strike, so the Strike button 86 is shaded accordingly. Also, the user's response time 96 of 4.812 seconds and score 98 of 10 are displayed near the buttons 84, 86. The fourth indicator 89 is filled in, and can be shaded to show that the response was correct. The time bar indicates that additional time has elapsed. The user's total score 92 as displayed remains 20 points, but will soon be updated to display 30 points with the 10 points earned because of the correct response to the fourth pitch.

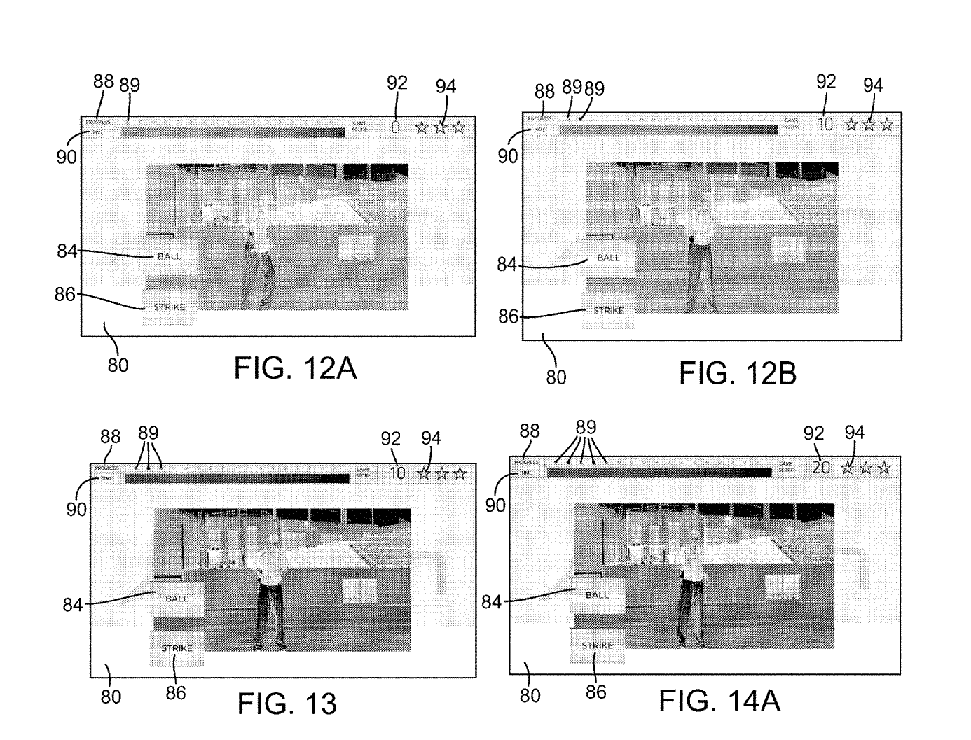

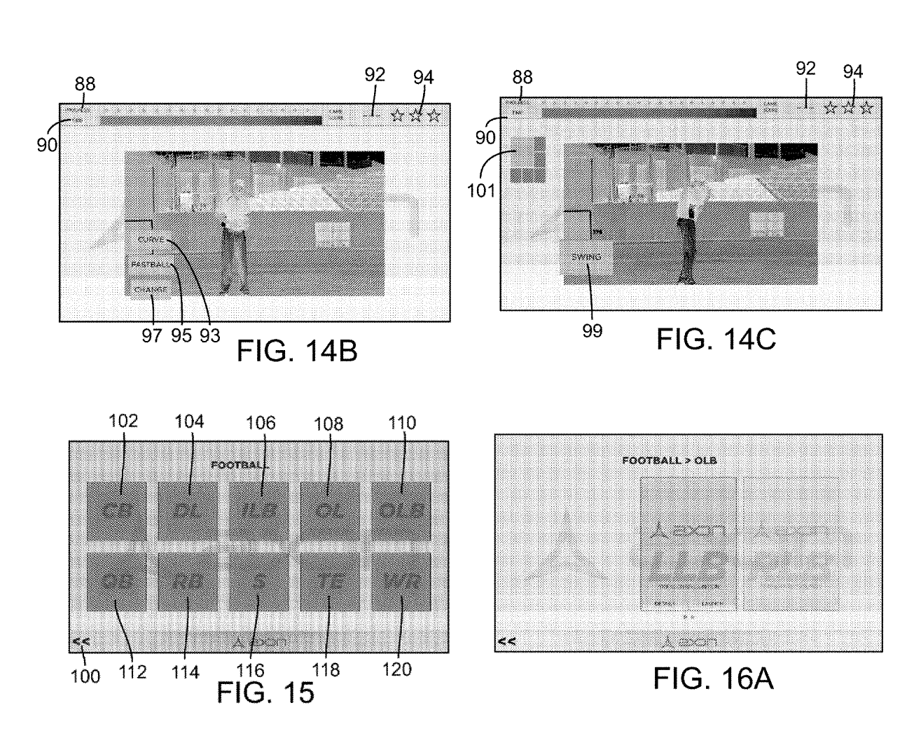

For the sake of further illustration, FIGS. 12A and 12B show views of another, different Ball/Strike scenario after a first pitch has been responded to incorrectly (FIG. 12A) and a second pitch has been responded to correctly (FIG. 12B). In the progress bar 88, FIG. 13 shows three filled indicators to show that the user has responded to three pitches. FIG. 14 is a screen shot taken subsequently after the user has responded to five pitches and scored a total of 20 points.

In addition to the Ball/Strike scenario, users can select the Pitch Recognition scenario 44 from the screen 40 (FIG. 5). In the Pitch Recognition scenario, the user attempts to select the pitch that is being thrown by the pitcher by observing the pitcher's delivery. Thus, the user can be presented with buttons such as Curve, Fastball and Change (or “changeup”). The buttons may be arranged such that one button, referred to as a home button, is slightly larger and/or slightly more centrally located than the other buttons. The home button would typically be the statistically most probable correct response, so in a pitch recognition scenario, the home button would likely be the fastball button.

In the Pitch Recognition example of FIG. 12C, a user is facing a left-handed pitcher and is batting left-handed. Thus, the buttons appear on the left side of the figure. Specifically, there is a Curve button 93, a Fastball button 95 and a Change button 97. The Fastball button 95 is the home button, so it is centrally located and larger relative to the other buttons. Although not shown for this example, the same types of user feedback, such as correct response, response time, current score, total score, rating, etc. can be provided substantially in real-time and within the scene of the scenario.

Also, it is possible to allow users to practice batting with the system. According to the batting scenario, the user must properly time her selection of a Swing button to correspond with arrival of a pitch with the strike zone. In FIG. 12D, the user is a left-handed batter facing a left-handed pitcher. To practice with the system, the user presses the Swing button 99 to attempt to hit the pitch. In some modes, the system determines whether the user's response in pressing the Swing button is timed correctly. A strike zone graphic 101 can be provided to help the user train for hitting pitches of a certain type and/or location within the strike zone. In some modes, the user is trained to “watch for her pitch” and to ignore strikes or near strikes that do correspond to “her pitch.” Different portions of the strike zone graphic can be shaded, illuminated or otherwise formatted to provide the user with feedback and instruction.

### Football Scenarios

To select a football scenario, the user selects the Football button 26 from the screen 100 as shown in FIG. 3. A menu of options is presented, such as the position menu shown in FIG. 15. As indicated, the user can select from various positions, e.g., a cornerback (CB) button 102, a defensive lineman (DL) button 104, an inside linebacker (ILB) button 106, an offensive lineman (OL) button 108, an outside linebacker (OLB) button 110, a quarterback (QB) button 112, a running back (RB) button 114, a safety (S) button 116, a tight end (TE) button 118, and a wide receiver (WR) button 120.

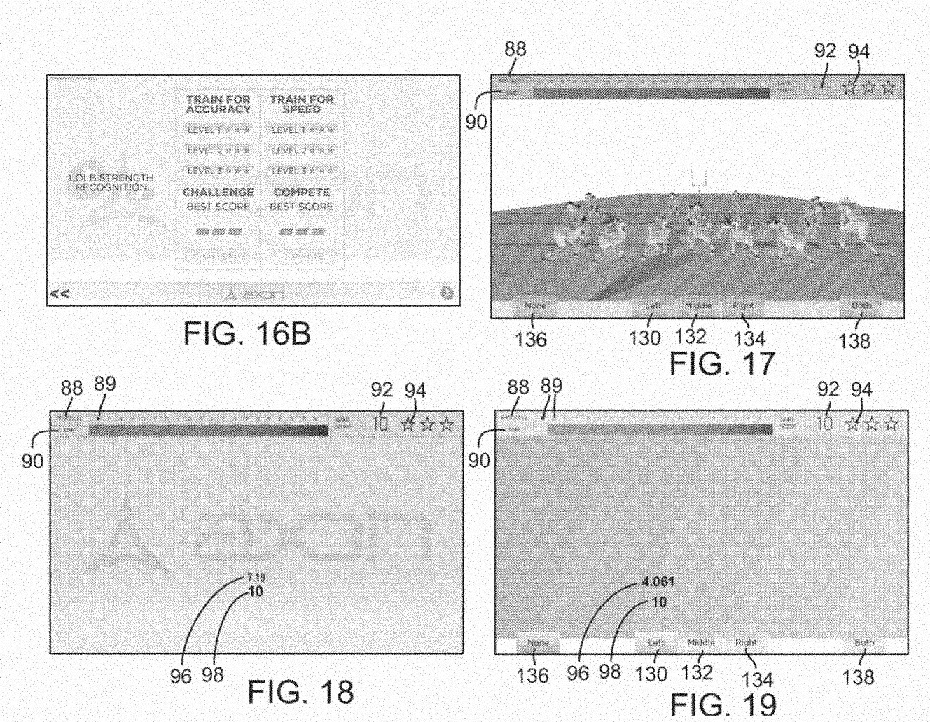

Assuming the user has selected the outside linebacker (OLB) button 110, then the screen shown in FIG. 16A is displayed. The user can then select between playing the left outside linebacker position or the right outside linebacker position. After selecting the left outside linebacker position, in FIG. 16B the user is presented with options to train for accuracy or to train for speed. The user chooses to train for accuracy.

In FIG. 17, the screen display shows a video segment of a football play being viewed from the perspective of the user in his role as the left outside linebacker. This scenario requires the user to correctly recognize where a blitz may occur, thereby training the user to recognize a blitz more quickly and accurately. The user can select from the Left button 130, the Middle button 132 or the Right button 134 to indicate that the blitz is coming from the left side, middle or right side of the defensive line. If the user decides that no defensive player will be rushing the quarterback, then the user selects the None button 136. Conversely, if the user decides that multiple defensive players will rush the quarterback, then the user selects the Both button 138.

As in the baseball scenarios described above, the progress bar 88, the time bar 90, the game score field 92 and the star ratings 94 provide feedback to the user of the system during football scenarios.

In FIG. 18, the blitz recognition scenario is shown directly following the user's response and while the scene is still occluded. The user has answered correctly that the blitz is coming from the middle. The user's response time 96 of 7.19 seconds and his score 98 of 10 points are indicated. These quantities may be shaded, such as in green, to convey that the response was correct. The first indicator 89 is filled in to indicate that the first play has been completed. The game score field 92 has been updated to indicate that the user earned 10 points.

In FIG. 19, the user has answered incorrectly that the blitz is coming from the left side. The user's response time 96 of 4.461 seconds and his score 98 of 0 points are indicated. These quantities may be shaded, such as in red, to convey that the response was incorrect. The correct response was None, i.e., there were no players rushing the quarterback. Thus, the None button 126 can be shaded or otherwise highlighted to provide feedback of the correct response to the user. The second indicator 89 is filled in to indicate that the second play has been completed. Since no points were scored, the game score field 92 continues to display 10 points.

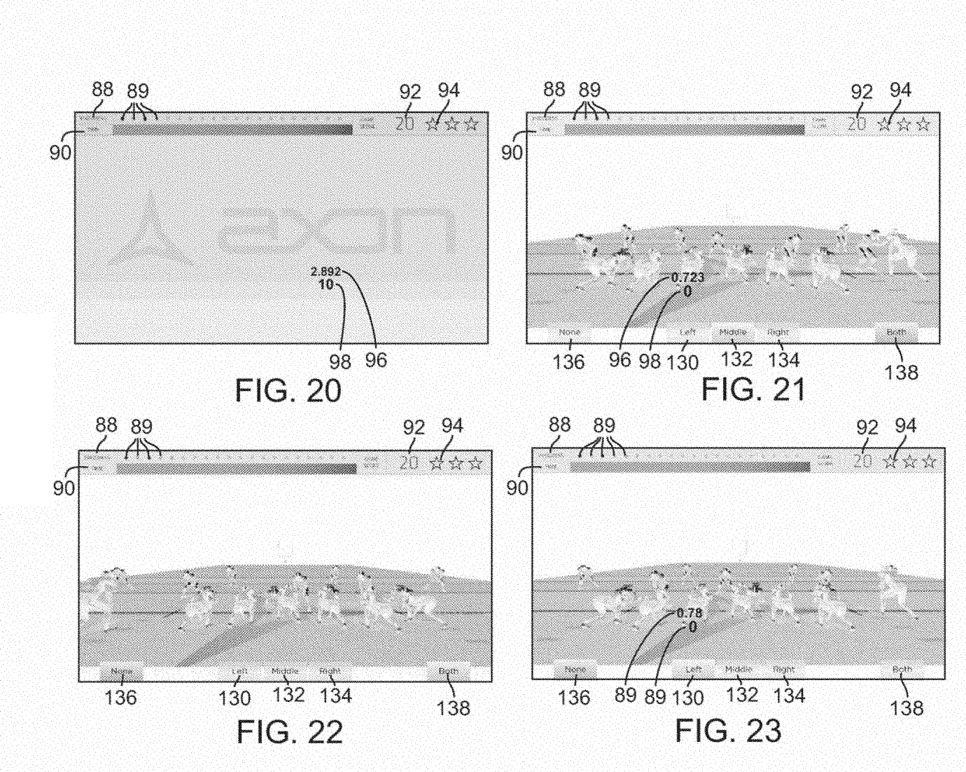

In FIG. 20, the user has answered correctly that the blitz is coming from the right side. The user's response time 96 of 2.982 seconds and his score 98 of 10 points are indicated. The third indicator 89 is filled in to indicate that the third play has been completed. The game score field has been updated to indicate a current score of 20 points.

In FIG. 21, the user has answered incorrectly that the blitz is coming from the middle. The user's response time 96 of 0.721 seconds and his score 98 of 0 points are indicated. The correct response was both, i.e., multiple players were rushing the quarterback. Thus, the Both button 138 is shaded or otherwise highlighted to provide feedback of the correct response to the user. The fourth indicator 89 is filled in to indicate that the fourth play has been completed. Since no points were scored, the game score field 92 continues to display 20 points.

In FIG. 22, the user has again answered incorrectly that the blitz is coming from both sides. The user's response time 96 of 0.834 seconds and his score 98 of 0 points are indicated. The correct response was none, i.e., no players were rushing the quarterback. Thus, the None button 136 is shaded or otherwise highlighted to provide feedback of the correct response to the user. The fifth indicator 89 is filled in to indicate that the fifth play has been completed. Since no points were scored, the game score field 92 continues to display 20 points.

In FIG. 23, the user has again answered incorrectly that the blitz is coming from the left side. The user's response time 96 of 0.783 seconds and his score 98 of 0 points are indicated. The correct response was none, i.e., no players were rushing the quarterback. Thus, the None button 136 is shaded or otherwise highlighted to provide feedback of the correct response to the user. The sixth indicator 89 is filled in to indicate that the sixth play has been completed. Since no points were scored, the game score field 92 continues to display 20 points.

In FIG. 24, a different football scenario configured for teaching recognition of offensive formations is shown. The user must decide whether the offensive line shows strength on the left side, strength on the right side or strength on both sides (in which case, the offensive line is defined as being “balanced”). Showing strength on the left side means more players in certain positions (such as tight ends, running backs and receivers) are lined up on the left side of the ball than on the right side. Thus, it would be predicted that the play would proceed on the strong left side (unless a trick play is employed), and thus the defensive player should anticipate accordingly. The user indicates her response by pressing the Left button 140, the Balanced button 142 or the Right button 144.

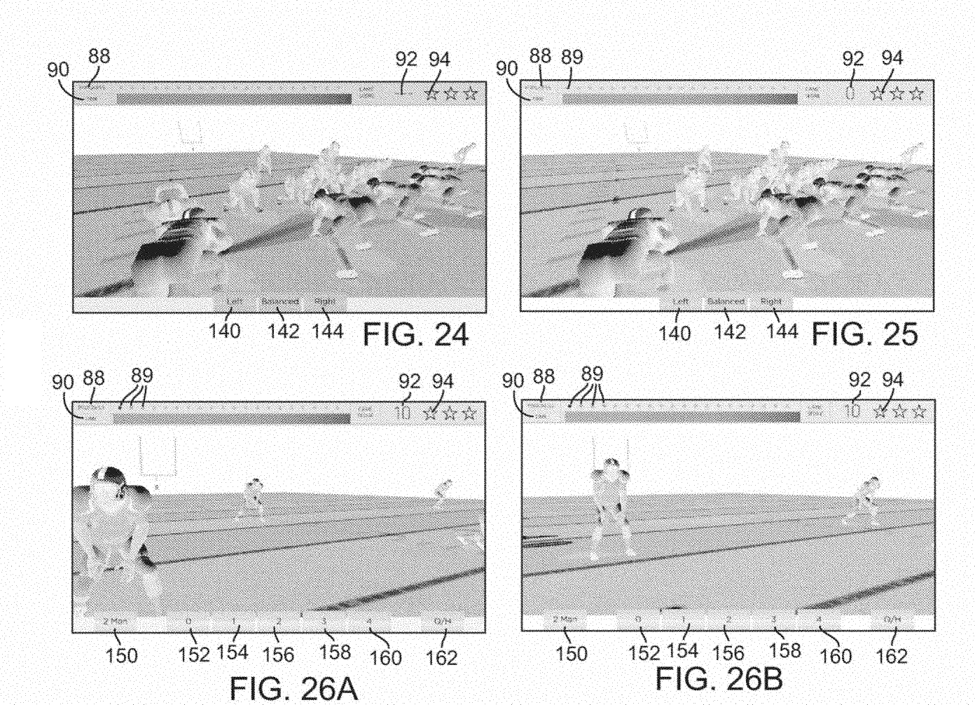

In FIG. 25, the user has responded incorrectly to the first offensive formation recognition (the correct response was “Balanced”). Thus, one indicator 89 is shown filled in within the progress bar 88, and the game score field 92 shows zero points. The user is now prompted to respond regarding the offensive formation displayed in FIG. 25. The user should press the Balanced button 142 because both sides of the offensive formation show about the same strength.

FIG. 26A shows a different football scenario in which an offensive player trains at recognizing defensive coverages. As seen in FIG. 26A, the offensive player responds by selecting from a Cover “2 Man” button 150, a “0” button 152, a “1” button 154, a “2” button 156, a “3” button 158, a “4” button 160 and a “Q/H” button 162. The user, in her role as an offensive player, strives to select the button corresponding to the number of defensive players playing back of the line. Thus, if all defensive players appear prepared to rush, then zero defensive players are playing back of the line, and the user would select the “0” button 152. Conversely, if all defensive players appear prepared to play back of the line, then the user would select the “5” button 160. The Cover “2 Man” button is correctly selected if the defense is showing the Cover 2 Man formation, with two safeties having deep coverage responsibility and while the cornerbacks and linebackers follow their respective assignments in one-on-one man coverage. The user selects the “Q/H” button 162 if she determines the defense is showing a quarter defense (3 down linemen, one linebacker and seven defensive backs) or half dollar defense (eight defensive backs). As can be seen from the progress bar 88, three iterations have been completed.

In FIG. 26B, the fourth iteration of the defensive coverage recognition scenario has been completed. The user's response was incorrect, so the game score field 92 still shows 10 points.

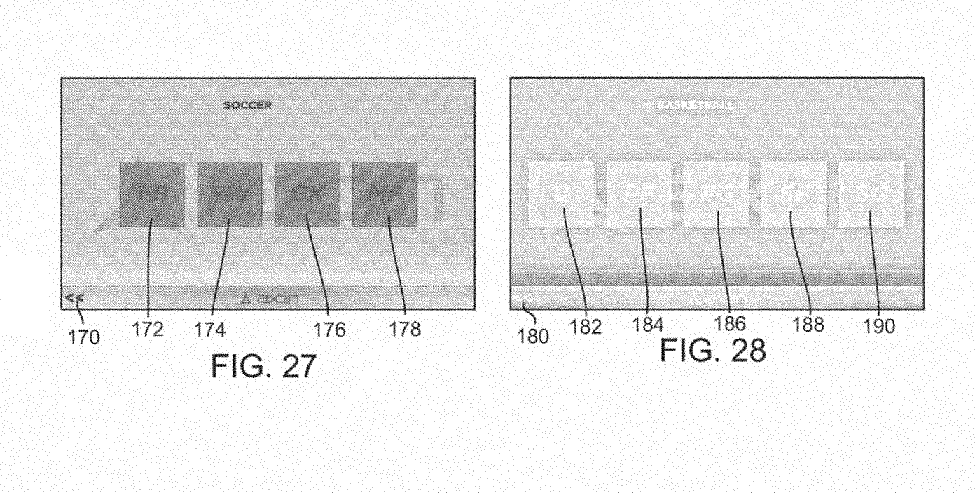

In FIG. 27, a screen 170 showing the options for different positions available for training in a soccer scenario are shown. The user can select a FB (fullback) button 172, a FW (forward) button 174, a GK (goalkeeper) button 176 or a MF (midfielder) button 178. Once a position is selected, then the system allows for the user to choose from a number of different training scenarios, similar to the approach described above for baseball and football.

In FIG. 28, a screen 180 showing the options for different positions available for training in a basketball scenario are shown. The user can select a C (center) button 182, a PF (power forward) button 184, a PG (point guard) button 186, a SF (small forward) 188 or a SG (shooting guard) button 190. Once a position is selected, then the system allows for the user to choose from a number of different training scenarios, similar to the approach described above for baseball and football.

In each of the various scenarios described above, it is possible to use response-time weighted scoring and negative scoring. For example, the score for a correct response may be worth 20 points if completed in 2 seconds, but only 10 points if completed in 4 seconds. It is also possible to assign a negative score if a user answers too quickly, i.e., to penalize a user attempting to game the system by answering randomly and/or to help the user develop a sense of timing (such as is valuable in avoiding an offside penalty in football). Thus, a response within 1 second may trigger a score of −10 points based on a determination that the user could not have appreciated the scene and answered correctly within that timeframe. Different users, whether in head-to-head play or separate play, may be assigned different point values for their respective responses based on their respective positions, handicap levels, experience levels, etc.

Negative scores can also be imposed according to any predetermined strategy, such as, e.g., to penalize users in certain positions for actions or omissions deemed to be serious errors, to penalize certain users in head-to-head competitions, etc. For example, a user in a role of batter facing a pitcher may incur a substantial penalty for striking out by failing to swing when the batter is ahead in the count. Thus, the amount of points awarded or taken away can be modified to focus the user's attention on certain skills.

There are a number of different approaches that can be employed in presenting situations to the user to maximize the training value. The overall number of situations can be set to train the user for an appropriate length of time, as well as to maximize opportunities to repeat certain situations, either because they are important or the user has a demonstrated an increased need to train in that situation. The system can determine which situations to present to a user during a scenario based on all available situations and/or other factors, such as a user's incorrect response to particular situation triggers the system to repeat that situation. Thus, question branching logic can include the ability to offer questions to a user designed to train the user in an aspect of a skill of which the user previously demonstrated weakness.

As indicated, the scenarios described above typically would incorporate providing feedback to the user or users. Providing feedback is instrumental in training users to acquire and master skills. Users improve to a greater degree and with greater speed when they receive appropriate feedback. Measurable improvement in user scores has been observed in as few as about 4-6 scenarios of about 10-25 questions each. Thus, it can be predicted that a user will show improvement over the course of completing 100 repetitions (e.g., 5 scenarios of 20 questions each).

In scenarios where the user sees her response time, she can determine whether she is answering as quickly as in past exercises. By providing feedback on or very close to the video (i.e., “on screen”), and substantially in real time, little time is lost in correcting a user's incorrect response or reinforcing a user's correct response. Feedback can be provided in a number of different ways because various users will receive it differently. For example, visual feedback following an incorrect response can include showing a user a score of zero or negative points for the response, emphasizing/highlighting the correct response, etc. In addition to visual feedback, audio feedback can also be provided. For example, cheering sounds or other positive audio feedback can be played when the user responds correctly, and a negative sound can be played to alert the user of an incorrect response.

The user can be rated against her prior performance, against her peer's performance or against a predetermined scale or index (e.g., a scale according to all players of the same sex and age group). Such a rating can be part of the feedback provided to the user. For example, the star ratings in the examples described above can be determined according to many different factors. According to one example, a ½ star is “earned” if the user achieves a score of at least 7 points on average over 20 situations, i.e., 140 points total. A full star is earned for 120 points, two stars are earned for 160 points and three stars are earned for 190 points. The star calculations can be calculated and displayed in real time to give users an incentive to continue making correct responses during a scenario.

Over time, the information collected from a user's completion of several scenarios allows a rating to be determined for the user. In the case of sports scenarios, one such rating is a sports specific rating, i.e., a user that has completed scenarios for the football quarterback position can be assigned a rating based on her scores in the scenarios. The rating can be based on a predetermined objective standard (e.g., by evaluating how well the user performs certain actions such as recognizing defensive coverages, recognizing a blitz, recognizing open receivers, etc., which are exemplary high performance cognitive skills) and/or comparison to other users' scores, either among current users or among a broader set of users (e.g., using a historical database). The sports specific rating can take into account the user's current experience level (e.g., the user is a first-year quarterback in a Division II collegiate program). Such a rating provides a useful metric to coaches, scouts and others interested in measuring and developing a player's performance.

Ratings and assessments can be specific to various subcategories, such as performance against right-handed vs. left-handed pitchers, ability to recognize zone coverage vs. man-to-man coverage, as just two examples. Thus, strengths and weaknesses can be discerned, and the user can be given detailed feedback to address each.

The system can be configured to use various logical approaches in setting the number of question and determining their sequence, both initially and real-time during a scenario. The number of questions can be selected by the user or it can be preconfigured according to the selected scenario options. Typically, a default of at least 20 questions is configured for each scenario, but this default can be changed as appropriate.

The sequence of questions can be random, or the system can be configured to use question branching logic. In either case, the system can select from a question bank or group (e.g., 100 questions or situations) to present the user with 20 questions in the current selected scenario. The system can also be configured to select from unused questions for subsequent iterations of the same or a similar scenario. Multiple question banks or groups can be drawn from in the same scenario or as needed, or in any other appropriate fashion.

According to one example of question branching logic, an incorrect (or untimely) response by a user leads to an ancillary question. The system is configured to select the ancillary question because it tests or drills the same point that was tested or drilled in the question responded to incorrectly. If the user answers the ancillary question incorrectly, the system can be configured to answer additional ancillary questions (until the supply is exhausted) or until a set number is reached (e.g., three tries to answer correctly).

The scoring and question count can be configured in different ways. For example, it is possible to have the system disregard any ancillary questions in the count of questions presented. Thus, e.g., presentation of ancillary questions would not change count of questions shown in the progress bar 88.

There are a number of ways in which the difficulty of completing a particular sports scenario can be modified. For example, the system can decrease the allowable response time such that only correct responses provided within a shortened interval earn points (or even that responses outside of the shortened interval earn only deductions in score). Further, the sports scenario can be “loaded” to make responding correctly more difficult. Loading can be defined as requiring an additional internal or external cognitive demand which can potentially divert one's cognitive resources away from a primary task or function. Such loading can be derived from internal sources, such as provoking thinking about non-critical aspects (thus triggering use of focus and/or splitting one's attention), not forgetting a previous mistake (thus triggering emotional regulation), etc. Such loading can also be from external sources as well, such as players asking questions while a quarterback is reading the defense, coaches yelling instructions, opponents shouting, crowds shouting, etc. Scoring distortions can be added to test/train/measure the user's emotional response and ability to operate with divided attention, which are attributes considered critical to developing an expert proficiency level.

In general, approaches to such loading are chosen to make the sports scenario more realistic and a closer simulation to the real world experience. For example, the user can be forced to process other stimuli or information while attempting to focus on the scenario. Two such types of stimuli are audio stimuli and visual stimuli. As alluded to above, audio stimuli may include crowd noise, white noise or other type of sound, perhaps even a spoken narrative selected to distract the user. As another example, the user could be given audio feedback (whether encouraging or discouraging), such as from the system, another player or a coach, that is inaccurate and/or inconsistent to further simulate such a real-world occurrence.

Visual stimuli can include the variable occlusion of the scene as discussed above, as well as the presentation of other visual imagery to the user, whether or not related to the scenario. In addition, the user can be required to complete an auxiliary task in an attempt to divert the user's attention from the scenario and to train the user's concentration and other cognitive skills. For example, the user can be required to make a motion (i.e., actuate a control or press a button) ancillary to responding to the scenario.

In the illustrated implementations, the user's domain-specific cognitive skills are assessed and trained. For example, a user is assessed and trained in football coverage recognition or in baseball pitch recognition. It is also possible to assess and train the corresponding generic cognitive skills as a step in assessing and training the specific skills. For example, instead of training pitch recognition by having a user face a simulated pitch, the assessment of pitch recognition could be made by assessing the user's skills in pattern recognition. The user could simply be asked to match the type of pitch to one of a series of different pitch types. Instead of real-time football coverage recognition, the user's generic skills in pattern recognition and/or spatial reasoning could be tested.

In the above examples, some of the scenarios follow an approach of teaching or reinforcing a part task that is component or closely associated with a whole task. For example, in the football scenarios, a quarterback can receive training in coverage recognition and blitz recognition, which are two part tasks closely associated with the whole task of throwing a successful forward pass.

In the above examples, each sports scenario involves a user responding to a video of a game situation. Any form of motion picture or still picture images can be used, and it is also possible to use computer-generated graphics to simulate game settings.

In the above examples, the on-screen controls selectable by a user are referred to “buttons.” As illustrated, each of such controls is embodied as an area of a touch-sensitive screen. It would of course be possible to configure such controls to be mechanical or hardware controls, or to use various other input devices configured to execute an input by motion. For example, and as further set forth above, the input device could be a mouse, a wand or other type of input device that relies at least in part on a user's movement to create an input. In addition, the system is configurable for use with voice recognition and motion recognition (e.g., Kinect technology and other motion-based input devices).

Through repeated training using the disclosed systems and methods, calibrated to an appropriate skill level and with prompt and direct feedback, users of varying abilities can be taught skills and can be trained to improve skills. A rating or other meaningful metric can be assigned based on a user's performance to date in selected scenarios, which can allow for a standardized approach in assessing candidates for teams or positions, generally determining strengths and weaknesses and/or comparing users to each other.

### Implementation of the Systems and Methods Disclosed Herein

Various systems carrying out training of users in the manners described above can be provided. In some embodiments, these systems may be implemented or performed by software stored on one or more tangible computer-readable media (e.g., one or more optical media discs, volatile memory or storage components (such as DRAM or SRAM), or nonvolatile memory or storage components (such as hard drives)) and executed on one or more computing systems. The computing systems can include one or more central processing units (CPUs) and a memory, such as random access memory (RAM) for temporary storage of information and/or a read only memory (ROM) for permanent storage of information, and a mass storage device, such as a hard drive, diskette, or optical media storage device. Typically, the modules of the computing system are connected to the computer using a standards-based bus system, such as, for example, Peripheral Component Interconnect (PCI), Microchannel, SCSI, Industrial Standard Architecture (ISA) and Extended ISA (EISA) architectures. The computing system may also include one or more commonly available input/output (I/O) devices and interfaces, such as a keyboard, a mouse, and/or a touchpad. In one embodiment, the I/O devices and interfaces include one or more display devices, such as a monitor, that allows the visual presentation of data to a user. More particularly, a display device provides for the presentation of Graphical User Interfaces (GUIs), application software data, and multimedia presentations, for example. The computing system may also provide a communications interface to various external devices.

Such software can be executed on a single computer or on a networked computer (e.g., via the Internet, a wide-area network, a local-area network, a client-server network, or other such network). The systems and methods disclosed herein can also be performed using cloud computing, a form of Internet-based computing, whereby shared resources, software and information are provided to computers and other devices on-demand. The software embodiments disclosed herein can be described in the general context of computer-executable instructions, such as those included in program modules, which can be executed in a computing environment on a target real or virtual processor. The computing system may run on a variety of computing devices, such as, for example, a server, a Windows server, a Structure Query Language server, a Unix server, a personal computer, a mainframe computer, a laptop computer, a cell phone, a personal digital assistant, a kiosk, an audio player, and so forth. The computing system is generally controlled and coordinated by operating system software. Conventional operating systems control and schedule computer processes for execution, perform memory management, provide file system, networking, and I/O services, and provide a user interface, such as a graphical user interface, among other things.

Furthermore, any of the software embodiments (comprising, for example, computer-executable instructions for causing a computer to perform any of the disclosed methods) can be transmitted, received, or accessed through a suitable communication device. Similarly, any data structure, data file, intermediate result, or final result created or modified using any of the disclosed methods can be transmitted, received, or accessed through a suitable communication device. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means now known or unknown. Moreover, any data structure, data file, intermediate result, or final result produced by any of the disclosed methods can be displayed to a user using a suitable display device (e.g., a computer monitor or display). Such displaying can be performed as part of a computer-implemented method of performing any of the disclosed methods.

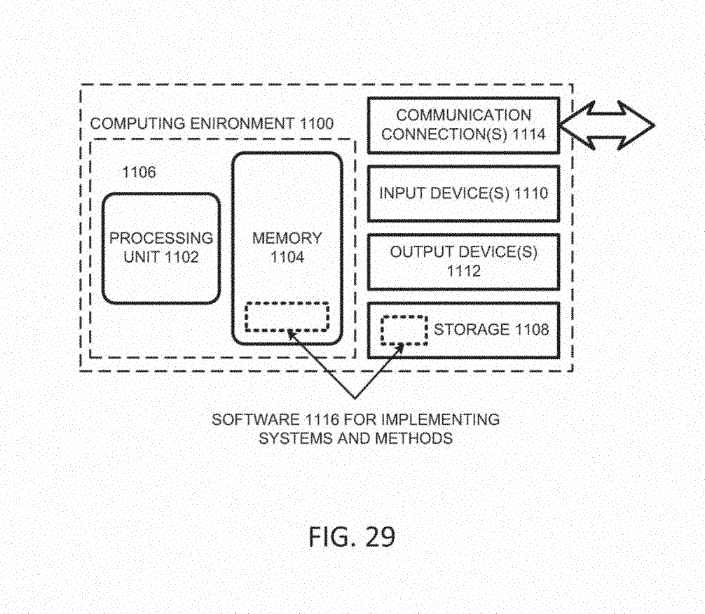

FIG. 29 illustrates a generalized example of a suitable computing environment 1100 in which the described embodiments of systems and methods of aggregating media content can be implemented. The computing environment 1100 is not intended to suggest any limitation as to scope of use or functionality, as the methods described herein can be implemented in diverse general-purpose or special-purpose computing environments.

With reference to FIG. 29, the computing environment 1100 includes at least one processing unit 1102 and memory 1104. In FIG. 29, this most basic configuration 1106 is included within a dashed line. The processing unit 1102 executes computer-executable instructions and may be a real or a virtual processor. In a multi-processing system, multiple processing units execute computer-executable instructions to increase processing power. The memory 1104 may be volatile memory (e.g., registers, cache, RAM), non-volatile memory (e.g., ROM, EEPROM, flash memory, etc.), or some combination of the two. The memory 1104 stores software 1116 implementing one or more of the systems described herein.

The computing environment may have additional features. For example, the computing environment 1100 includes storage 1108, one or more input devices 1110, one or more output devices 1112, and one or more communication connections 1114. An interconnection mechanism (not shown) such as a bus, controller, or network interconnects the components of the computing environment 1100. Typically, operating system software (not shown) provides an operating environment for other software executing in the computing environment 1100, and coordinates activities of the components of the computing environment 1100.

The storage 1108 may be removable or non-removable, and includes magnetic disks, magnetic tapes or cassettes, CD-ROMs, DVDs, or any other medium which can be used to store information and which can be accessed within the computing environment 1100. The storage 1108 can store instructions for the software 1116 implementing any of the described systems and methods.

The input device(s) 1110 can be a touch input device such as a touch-sensitive screen, keyboard, mouse, pen, or trackball, a voice input device, a scanning device, or another device that provides input to the computing environment 1100. In some cases, the input device may translate the user's physical movement into the input, such as via a wand or other manually manipulated element, or by motion of the user's body itself. For audio or video encoding, the input device(s) 1110 can be a sound card, video card, TV tuner card, or similar device that accepts audio or video input in analog or digital form, or a CD-ROM or CD-RW that reads audio or video samples into the computing environment 1100. The output device(s) 1112 can be a display or another device that provides output from the computing environment 1100 to view the selected media content.

The communication connection(s) 1114 enable communication over a communication medium to another computing entity. The communication medium is not a storage medium but conveys information such as computer-executable instructions, resource and construction project information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The various methods disclosed herein can be described in the general context of computer-readable media. Computer-readable media are any available media that can be accessed within or by a computing environment. By way of example, and not limitation, with the computing environment 1100, computer-readable media include tangible computer-readable storage media such as memory 1104 and storage 1108.

Any of the aspects of the technology described herein can also be performed using a distributed computer network. FIG. 10 shows a simplified embodiment of one such exemplary network. A server computer 1120 can have an associated storage device 1122 (internal or external to the server computer). For example, the server computer 1120 can be configured to perform the calculations and analysis of information according to any of the disclosed embodiments. The server computer 1120 can be coupled to a network, shown generally at 1124, which can comprise, for example, a wide-area network, a local-area network, a client-server network, the Internet, or other such network. One or more client computers, such as those shown at 1126, 1128, may be coupled to the network 1124 using a network protocol. The work may also be performed on a single, dedicated workstation, which has its own memory and one or more CPUs.

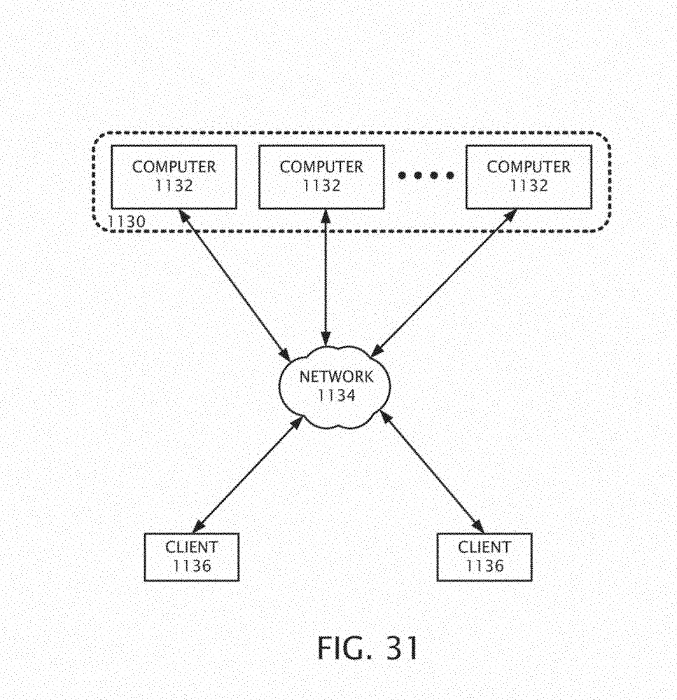

FIG. 31 shows another exemplary network, such as a network which can send and receive information and media content to the computing devices 1126, 1128, 1130. One or more computers 1132 communicate via a network 1134 and form a computing environment 1130 (e.g., a distributed computing environment). Each of the computers 1132 in the computing environment 1130 can be used to perform at least a portion of the calculation techniques according to any of the disclosed embodiments. The network 1134 in the illustrated embodiment is also coupled to one or more client computers 1136.

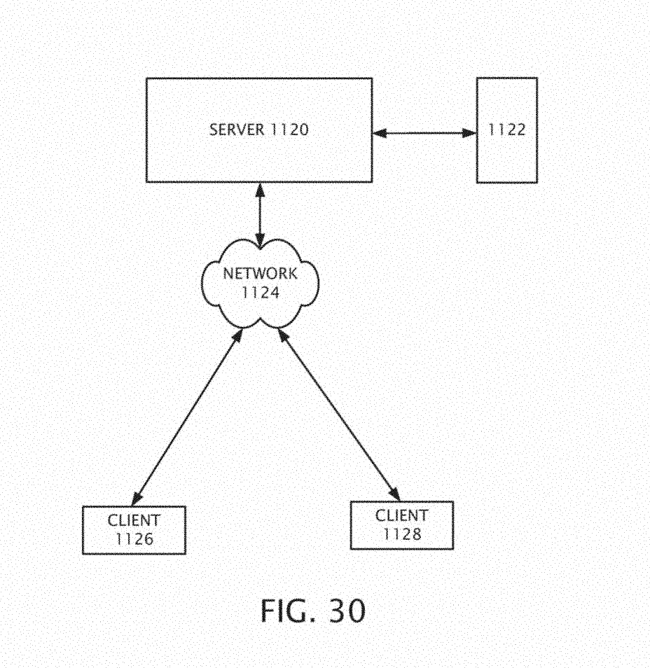

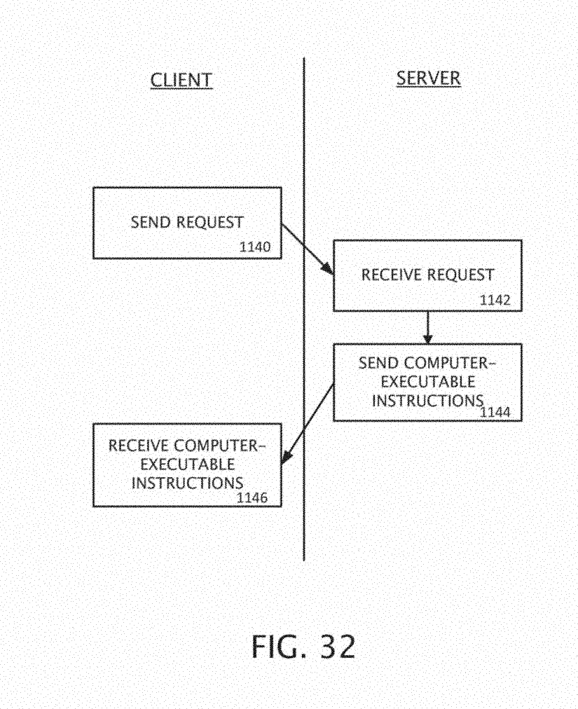

FIG. 32 shows one exemplary manner in which computer-executable instructions for performing any of the disclosed embodiments can be transmitted, accessed, or received using a remote server computer (such as the server computer 1120 shown in FIG. 30) or a remote computing environment (such as the computing environment 1130 shown in FIG. 31). At process block 1140, for example, the client computer sends a request to download computer-executable instructions for performing any of the disclosed methods or techniques (e.g., after registering or logging in to the system). In process block 1142, the request is received by the remote server or by respective components of the remote computing environment. In process block 1144, the remote server or computing environment transmits computer-executable instructions for performing any of the disclosed methods or techniques. At 1146, the computer-executable instructions are received (e.g., stored, buffered, and/or executed) by the client computer.

Graphical User Interfaces

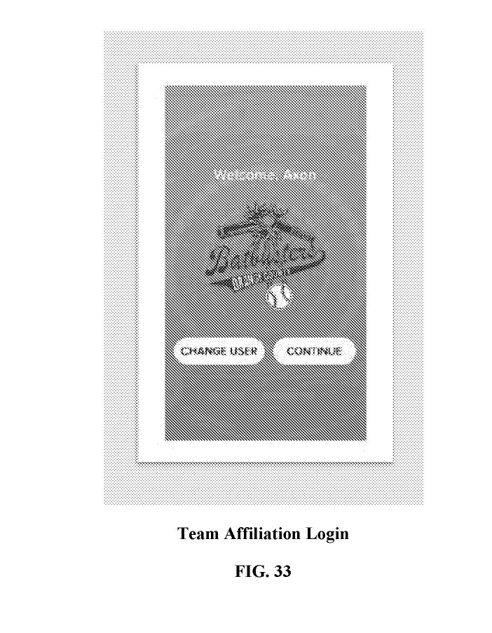

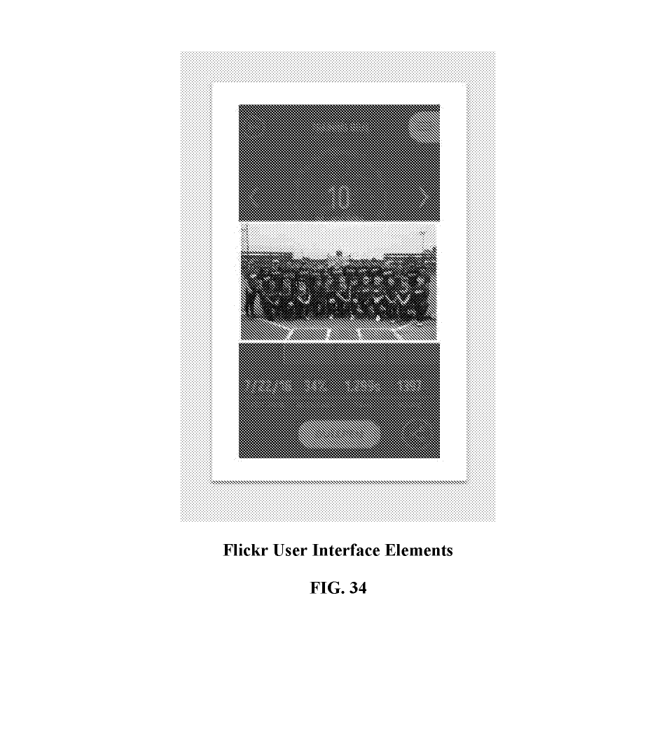

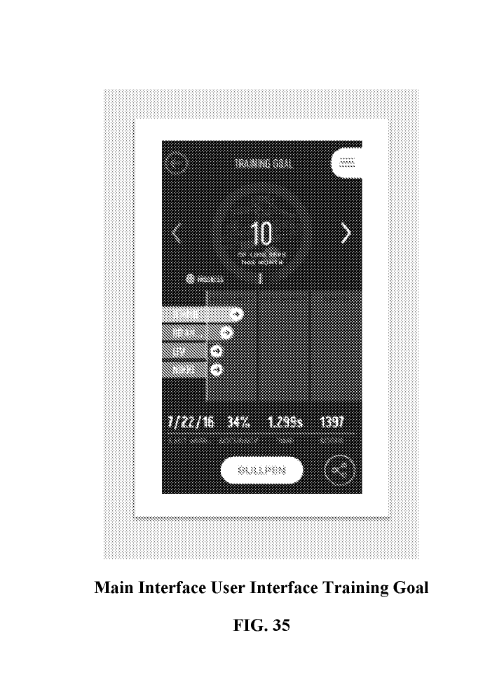

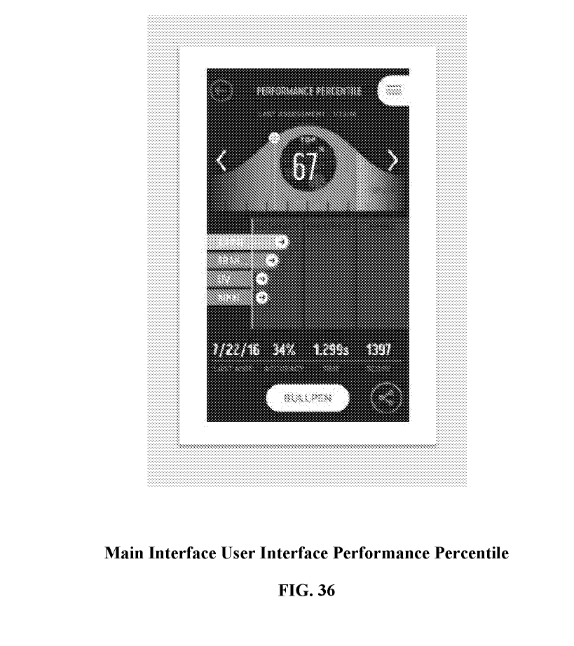

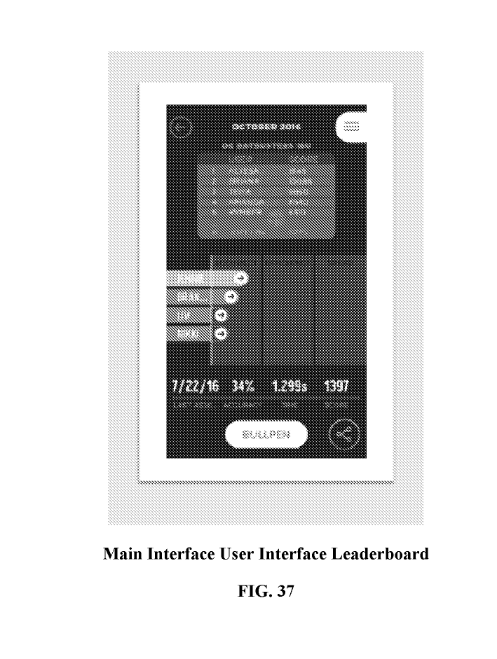

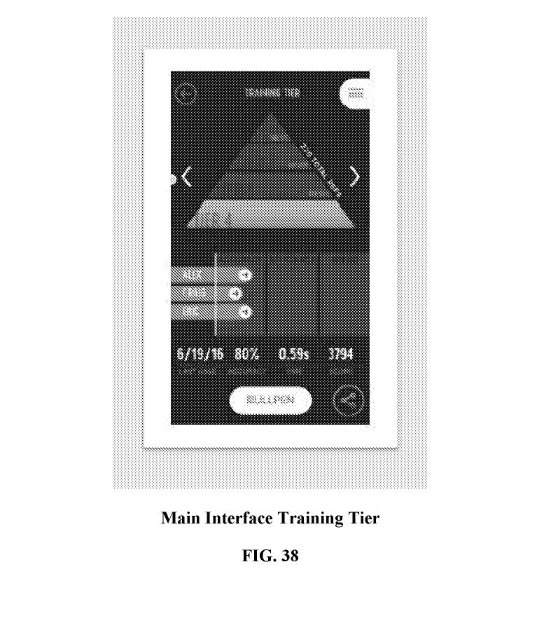

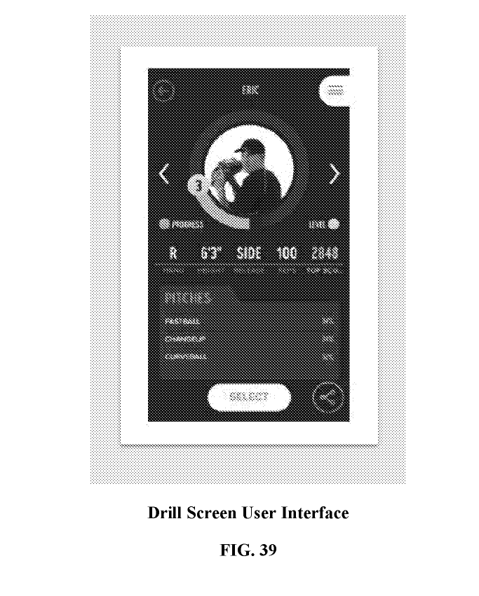

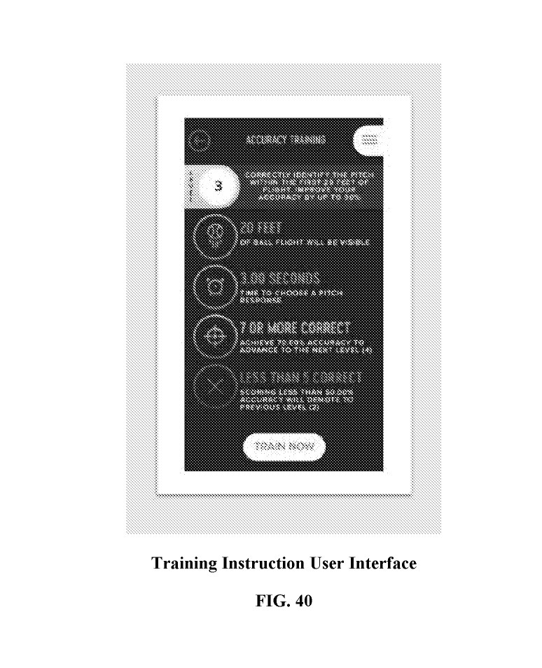

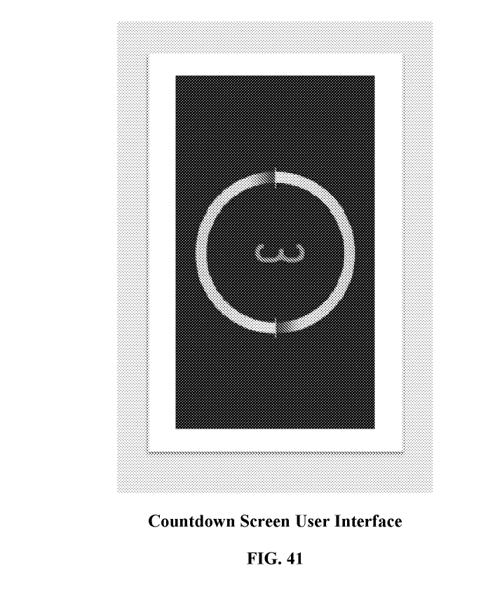

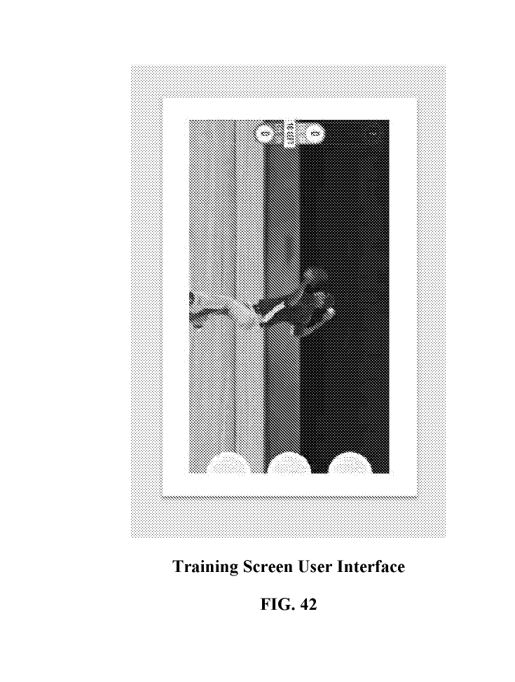

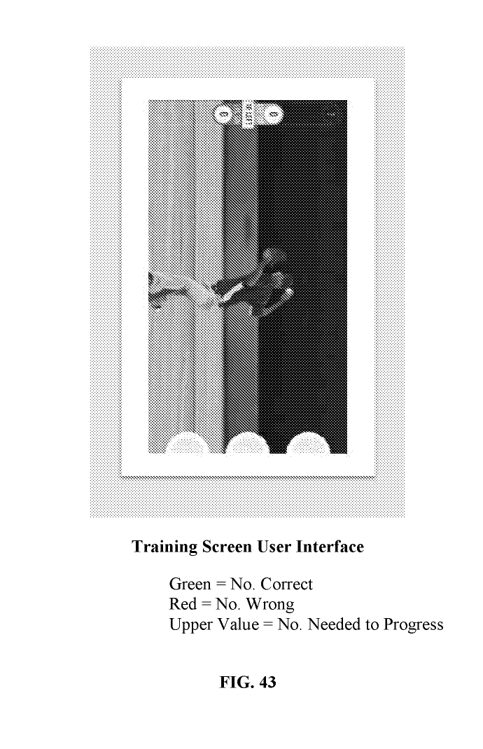

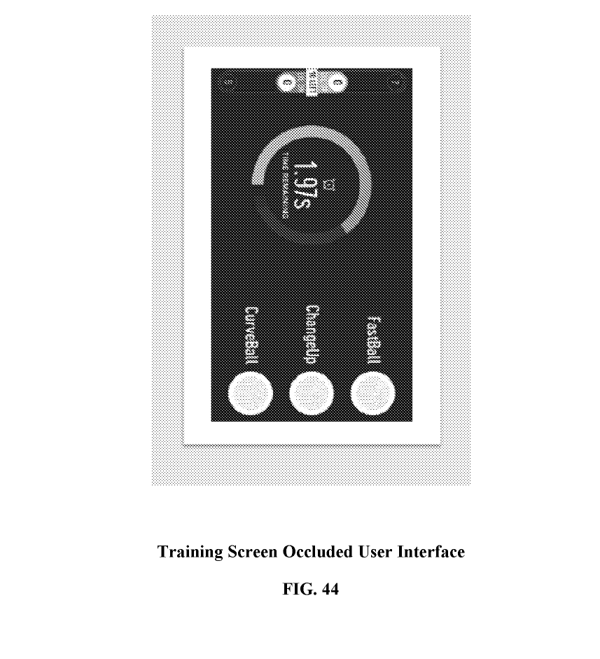

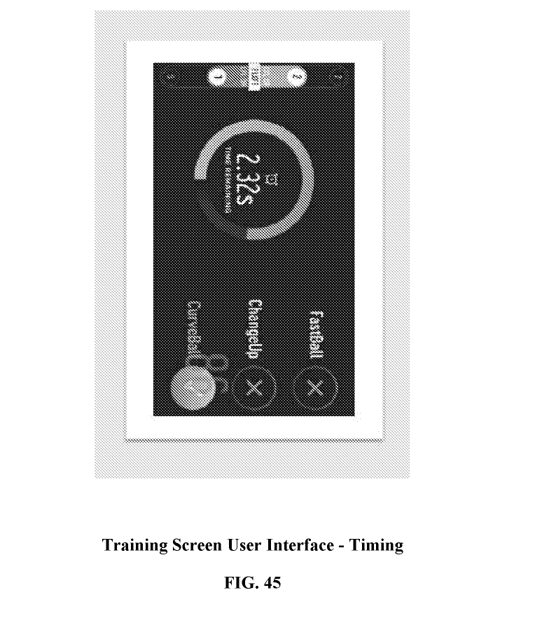

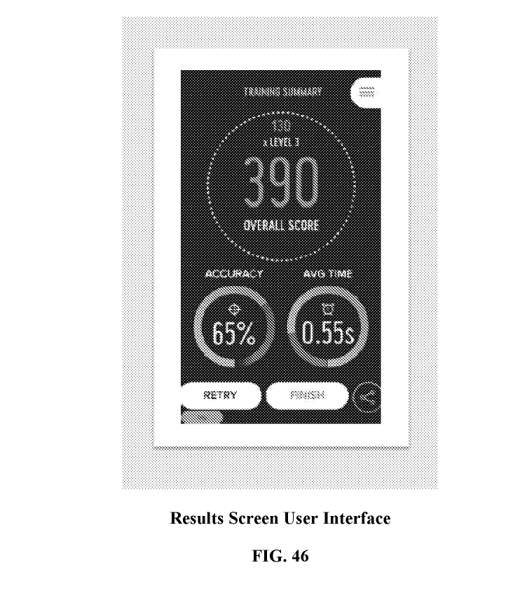

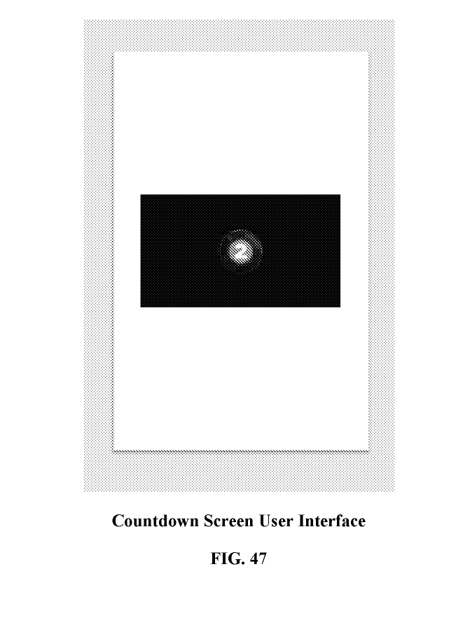

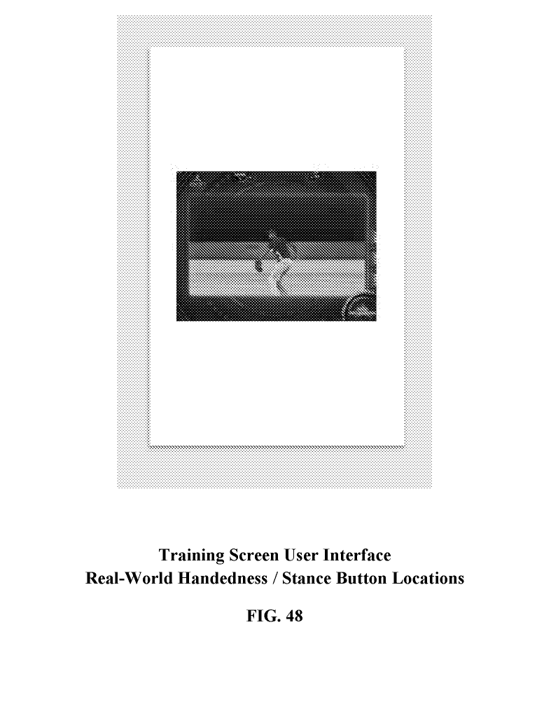

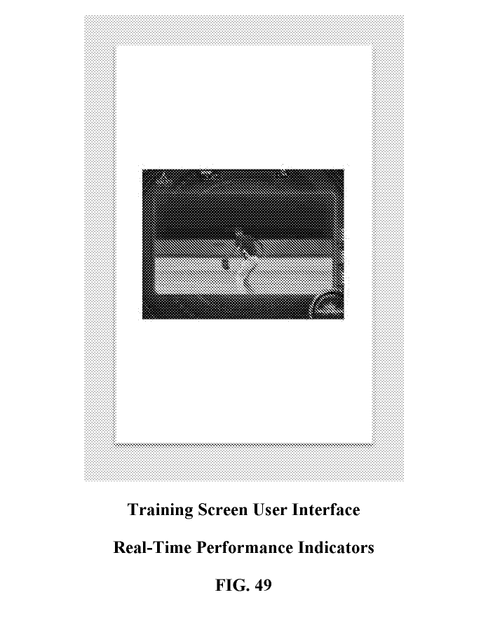

As discussed above, the embodiments of the invention include a graphical user interface. Referring now to FIGS. 33 to 49, an exemplary graphical user interface includes login, main interface, drill, and training instruction screens in the core user interface, and countdown, training, and results screens in the training interface. These screens are linked sequentially via user selectable icons such as buttons or arrows. For example, the login, main interface, drill, and training instruction screens may be sequentially linked by navigation arrows until the user enters the training interface and goes past the drill selection screen where buttons may be used when navigating within the training interface in order to prevent users from accidentally exiting training once entered.

The graphical user interface has team affiliation information which matches with user information gathered during account setup. For example, if a user is affiliated with a particular team, that team's logo and colors may be loaded from a database storing team affiliation information or uploaded by the user via a prompt during login. Team affiliation information serves to increase user engagement. Other custom theme elements may be displayed such as team photographs, leaderboard information regarding performance versus peers, and featured athletes which may preferably relate to the sport of the user or their training regimen (e.g. when the system is used to train pitching, the graphical user interface will display images of pitchers. These theme elements serve to increase user engagement. Team affiliation and theme elements may be displayed on the login screen and further screens based on corresponding information collected during user registration such as team affiliation, user's position on a team, or user's interests (e.g. favored team, a regional or national team based on user location, favored sport and/or position).

After user login, the main or core interface is displayed which is preferably composed of three elements organized from the top down: (a) dashboard element, (b) training and progress element, and (c) current score.

The dashboard element includes performance indicators such as training goal rep (repetition) count, a progress circle as the user's rep count goal is approached, performance percentile, leaderboard, training tier, and achievements. Performance percentile visually indicates where the user's latest assessment score is in the distribution of user scores and may be displayed as a bell curve graph with the percentile in a circle in the center for maximal viability. This performance percentile metric is automatically updated every time the user's device running the system's client software syncs with its networked server. The leaderboard is customized to show how a user is performing versus peers. Peers are based on those loaded into the system server as belonging to a user's organization and/or team and/or position (e.g. pitchers). For example a user may be assigned to a subset of athletes, for example, rookies, or they can be assigned to an entire team as desired. The training tier is for example a triangular depiction of the total repetitions completed by the user as compared to total repetitions from the database of users or predetermined subset thereof; for example using the same categories as the leaderboard. Repetitions completed is a key indicator of athletic performance.

The training and progress element displays the training available to a user and their progress through that training (preferably depicted by level) as compared to other users preselected similarly to those for the leaderboard (e.g. by team, position etc.). For example, in a softball application accuracy (level 1-5), efficiency (level 6-10) and speed (level 11-15) are shown.

The current score element displays the date and components of a user's last score and exists on all main menus to provide a constant reminder of the need to improve and retest. In the depicted example the score date of Jul. 22, 2016 is followed by a percentile score (accuracy), a time score and a calculated numeric score.

The second interface is the training interface. It is accessed from the main or core interface and begins the selection and training activities of the system for the user. Once a user selects a drill, the visual shows the selected drill, e.g. pitching. In the pitching example, the image of a pitcher is displayed surrounded by a circle depicting user progress and level and the bottom portion depicts details of the drill with measurements for those detail, e.g. in a pitching example, the percentage of pitches which are fastballs, changeups or curveballs. The next screen of the drill selection screen includes further parameters of the drill, indicating what must be accomplished to proceed to the next level. These parameters are color coded with blue being informational, green indicating a success criteria (level up) and red a failure criteria (level down). A train now button located at the bottom provides access to training. Once pressed the screen rotates to landscape and counts down until the training begins. The countdown is sufficiently long enough to allow the average person to be prepared and focused for training.

During training, the answer buttons are displayed on screen in a manner based on how an athlete would stand in the real world. For example, for a right handed batter training answer choices are presented on the right hand side, whereas for a left handed batter the buttons appear on the right hand side. However, for a quarterback, since they are squared up, the training buttons are distributed evenly across the screen. Further, training answer buttons are grouped in accordance with cognitive function—first the user must identify the correct category, then the correct answer within the category. Find time is increased in proportion to the number of choices, so as to not penalize a user score where the user is merely trying to locate the button corresponding to the answer they have deduced. A current performance indicator, which is mobile and adjustable, appears on the left of the screen typically. It shows in green the number of correct responses, how many correct answers are needed to progress to the next level, how many wrong answers will result in a level down, and how many wrong answers have been entered by the user. When a preselected limit on either level up or level down is reached the indicators begin to flash to add pressure to the user to complete a level up or avoid a level down. Optionally, to prevent a user from receiving too much information, the graphics on screen are occluded and only a timer, the current performance indicator, and the answer choices are displayed. The timer is structured as a circle that fills as time runs out and shows numeric time remaining. A color and sound indicator goes off when the correct or wrong answer is chosen. points achieved by the answer are displayed over the choices for impact. The time spent answering remains on screen to emphasize the need for speedy answers to increase score. When a wrong answer is provided the correct answer is highlighted to provide continuing education to the user.

A results screen is a training summary screen and is provided when the training session is finished. The results screen shows score in the upper section circle, which smaller circles below for accuracy and speed. Quick restart is prominently displayed to the lower left. Score is a multiplier based on level, thus making harder levels worth more points on the leaderboard. The accuracy and time circles also have prominent fillable circles surrounding them which visually represent progress or lack thereof by filling more of the circle with in the example blue color.

In still another embodiment an alternative graphical user interface is provided which adds the following features to the preceding embodiment (1) thumbprint scanner login and (2) a main interface screen having at the top left calendared repetition box also showing user score and last assessment date; in the middle left a leaderboard with leaders shown by preselected time (e.g. weekly); and middle right navigation options arranged by sport type, position type, and drill type or mode—e.g. football, quarterback, coverage recognition, training. The main interface can also display at middle left, a card for an opponent athlete the user is training against and providing information about said opponent athlete and at middle right a selection of athletes to train against. The middle left may also show a leaderboard. Upon selecting a drill, a user next progresses to the drill screen which may display a level bar on the middle right showing a user's current level in the system and a launch button. Repetitions completed is tracked above the level bar. The middle left is reserved for display of leaderboards. The drill's next screen can optionally show custom images to illustrate drill objectives—top right being stage of the assessment about to launch and bottom right images of criteria for success. After the countdown screen, discussed above, the training commences as described above with the addition of a time pressure bar on top and image files showing the correct answer in both text and image form. Images may be generated based on where a user presses the screen. For example:

A player is approaching a basket in basketball. The user is supposed to anticipate the direction the player is going. The user is instructed to press the defensive location on the depiction of the court, which may be a high resolution image or even an interactive photograph. When the user responds an image of a defender is rendered at the selected location. If correctly placed a success indication by color (e.g. green) and/or sound is played. If incorrectly placed a failure indication by color (e.g. red) and/or sound is played. Top located indicator dots display total correct, total wrong for a drill snapshot upon completion. The top right circle shows how many correct answers are needed to level. The lower right corner shows which drill is in progress.

In view of the many possible embodiments to which the principles of the present disclosure can be applied, it should be recognized that the illustrated embodiments are only examples and should not be taken as limiting the scope of the following claims. We therefore claim all that comes within the scope and spirit of these claims.

1. A graphical user interface for a sports training system comprising:
(a) a main interface having a navigable performance percentile, leaderboard and training tier, and
(b) an active training screen where user selections are placed based on where a depicted athlete is standing or directly corresponding to the athlete's handedness.
